(19) United States
(12) Patent Application Publication
(10) Pub. No.: US 2007/0076764 A1
(43) Pub. Date: Apr. 5, 2007

(54) Digital broadcasting method using communication channel and its apparatus

(75) Inventors: Hiroshi Kawada, Tachikawa-shi (JP); Noriya Sakamoto, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/500,463

(22) Filed: Aug. 8, 2006

(30) Foreign Application Priority Data
Sep. 30, 2005 (JP) 2005-288388

(51) Int. Cl. H04J 3/06

(52) U.S. Cl. 370/503; 370/350

(57) ABSTRACT

According to one embodiment, an MPEG2-TTS is generated by adding time stamps to each packet in an MPEG2-TS (step ST41) and the MPEG2-TTS is transmitted to a communication channel (the Internet, etc.) (step ST45). At this time, if null packets are included in an original MPEG2-TS, all null packets are removed from the MPEG2-TTS before it is transmitted. Thereby, an averaged rate of data transfer is decreased. Since each packet in the MPEG2-TTS has a time stamp, each packet can be decoded at original timing then synchronization of broadcasting times between a transmission and a reception is secured.

### CROSS-REFERENCE TO RELATED APPLICATIONS

This application is based upon and claims the benefit of priority from Japanese Patent Application No. 2005-288388, filed Sep. 30, 2005, the entire contents of which are incorporated herein by reference.

### BACKGROUND

1. Field

One embodiment of the invention relates to a method and an apparatus for broadcasting digital information packets via a communication channel. More specifically, the present invention relates to an Internet Protocol (IP) broadcasting time synchronization system to broadcast a packet of moving picture information [MPEG2-transport stream (TS), etc. requiring a high transfer rate by using an IP via a communication channel.

2. Description of the Related Art

In recent years, digitalization (for example, a terrestrial digital broadcast and a satellite digital broadcast) of a broadcasting system, such as a television (hereinafter, referred to as TV) has been widely prevailed. Such a digital broadcast utilizes an MPEG-TS with a video and a sound multiplexed therein. For a transmission of the MPEG2-TS as a TV broadcast by radio waves, the MPEG2-TS adds a program clock reference (PCR) thereto and transmits signals at a fixed rate. Therefore, a reception side can obtain synchronization between a transmission and a reception to prevent the reception side from reproducing the signals earlier or with delay in comparison to transmission data.

In contrast, for a transmission of the MPEG2-TS via a network, it is not always secured that the signals are transmitted and received at the fixed rate, so that a broadcasting time lag may occur. As a countermeasure for this time lag, for example, a broadcasting system to transmit information about the number of abandoned packets at a transmission side and generate/reproduce packets, by the number of the abandoned packets, at a reception side is a possible approach (refer to Jpn. Pat. Appln. KOKAI Publication No. 2000-187940).

On the other hand, a high-definition MPEG2-TS TV broadcast (high-definition moving picture information) requires a high transfer rate (for example, 24 Mbps or more), which makes it possible to perform via a network (a communication channel, such as the Internet). As a countermeasure, a broadcasting system in which information not directly related to content (null packet, etc.) from the MPEG2-TS to decrease a substantially averaged rate is possible (refer to Jpn. Pat. Appln. KOKAI Publication No. 2003-115807).

An object of the present invention is to provide a digital broadcasting method (by using a communication channel) and apparatus that does not require generation/reproduction of abandoned packets at a reception side and is capable of effectively decreasing an averaged rate of data transfer.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an explanatory view explaining an IP broadcasting time synchronization system according to an embodiment;

FIG. 2 is an explanatory view explaining a packet structure change for eliminating a null packet after converting an MPEG2-transport stream (TS) into an MPEG2-time-stamped transport stream (TTS);

FIG. 3 is an explanatory view explaining an IP broadcasting time synchronization system according to another embodiment;

FIG. 4 is a flowchart explaining an example of a procedure to convert the MPEG2-TS into the MPEG2-TTS to output it;

FIG. 5 is a flowchart explaining an example of a procedure to output packets in normal sequence at a reception side;

FIG. 6 is a flowchart explaining an example of a clock adjustment procedure at the reception side;

FIG. 7 is a flowchart explaining another example of a clock adjustment procedure at the reception side;

FIG. 8 is an explanatory view explaining an example how data formats and averaged transfer rates of the MPEG2-TS and MEPG2-TTS change, respectively, in processes of processing at a transmission side and a reception side;

FIG. 9 is a explanatory view explaining an example of packet exchange processing by a real-time transport protocol (RTP);

FIG. 10 is an explanatory view explaining an example of a data structure of an RTP packet;

FIG. 11 is a explanatory view explaining an example of a forward error correction (FEC) used for the RTP packet;

FIG. 12 is an explanatory view explaining an example of a transfer rate change accompanied with processing at the transmission side and a transfer rate change accompanied with processing at the reception side;

FIG. 13 is an conceptual view explaining processing to reduce network jitters; and

FIG. 14 is an explanatory view explaining a configuration example to perform clock recovery processing.

### DETAILED DESCRIPTION

Various embodiments according to the invention will be described hereinafter with reference to the accompanying drawings. In general, according to one embodiment of the invention, a digital broadcasting method comprises adding time stamps to each packet in an MPEG-encoded first data stream to generate a second data stream and transmitting the second data stream to a communication channel.

For a transmission of an MPEG-TS via a network, the transmission does not always assure transmissions and receptions of signals at a fixed rate, so that a broadcasting time lag probably occurs. As a means to solve this problem, an embodiment of the present invention uses an MPEG2-TTS in which time stamps are added to each packet of the MPEG2-TS. However, the MPEG2-TTS has a defect such that a packet size thereof becomes large (for instance, adding of a 4-bite time stamp to a TS packet of 188-bite becomes 192-bite in total). Even if the MPEG2-TS is in the form of MPEG2-TTS, the embodiment still reproduces on the basis of a clock incorporated in equipment to receive the MEPEG2-TTS. Therefore, an error of a reference clock produces the broadcasting time lag and it destroys a buffer model of a reception side encoder to fail in reproduction of a video if things come to the worst. Accordingly, the embodiment of the present invention counters the aforementioned problem by the method described below.

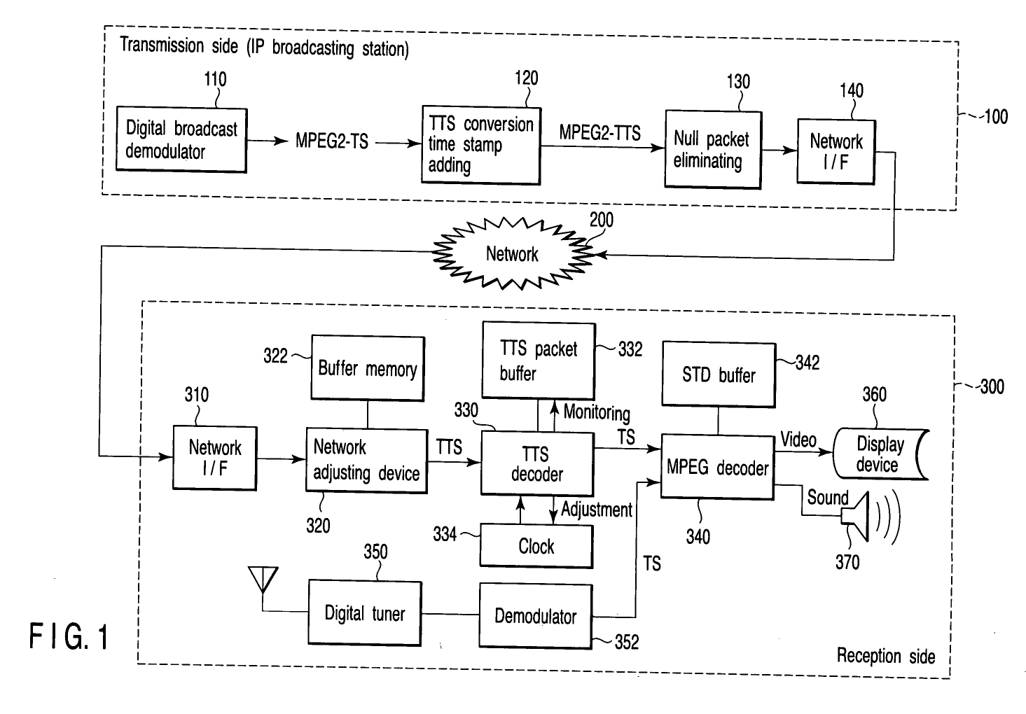

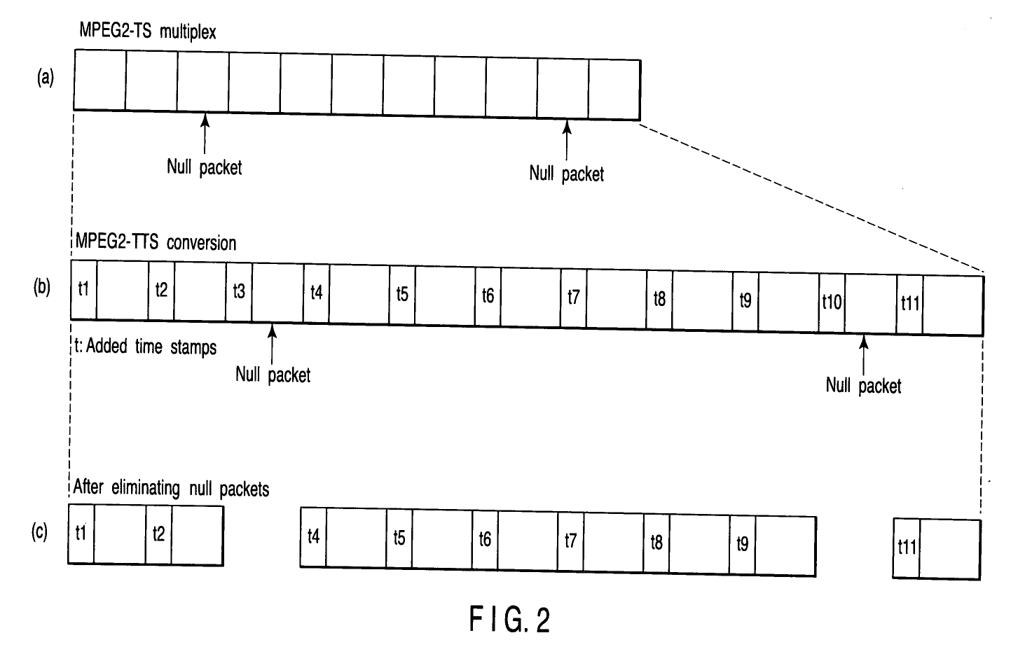

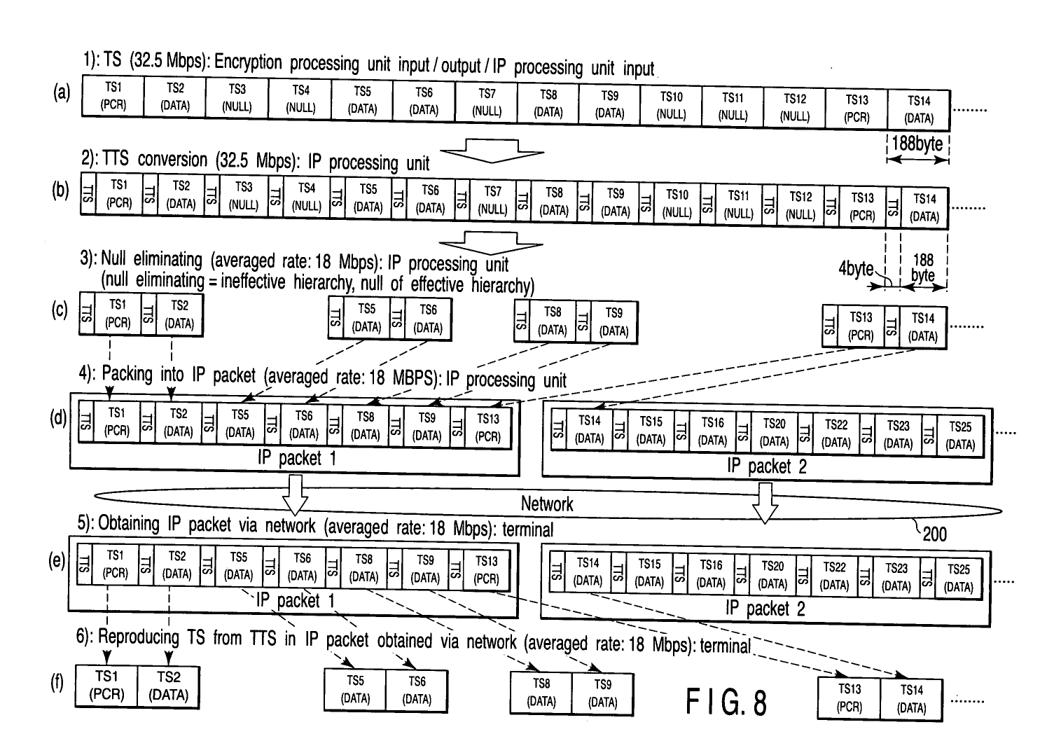

FIG. 1 is an explanatory view explaining the IP broadcasting time synchronization system regarding the embodiment of the present invention. This system configuration is mainly divided into a transmission side 100 and a reception side 300. The transmission side firstly converts the MPEG2-TS which has been usually used into the MPEG2-TTS. At this time, ‘addition of time stamps’ is performed. That is, the transmission side 100 adds the time stamps to each packet [refer to (a) of FIG. 2, or (a) of FIG. 8 in a data stream of an MPEG2-TS output from a digital broadcast demodulator 110 by a TTS conversion time stamp adding unit 120 [refer to t1, t2, . . . , in (b) of FIG. 2, or TTS in (b) of FIG. 8].

In this case, when being encoded from an original video at a broadcasting station, etc., packets not including a video, etc., (hereinafter, referred to as null packets) to adjust reproduction timing have been inserted to the MPEG2-TS to be an origin [refer to (a) and (b) of FIG. 2, or (a) and (b) of FIG. 8]. Furthermore, in a terrestrial digital broadcast, the null packets are inserted into actual transmission signals so as to enable selecting any one of a QPSK, 16 QAM or 64 QAM as a modulation system. To insert the null packets, a null packet eliminating unit 130 eliminates null packets not necessary for reception processing [refer to (c) of FIG. 2, or (c) of FIG. 8].

Like this, the null packets to be eliminated may be not only null packets caused by modulation processing but also null packets inserted to adjust reproduction timing by encoding processing. That is, all null packets in the MPEG2-TTS before transmitting can be eliminated. Since the time stamps have already added to the MPEG2-TTS before entering the null packet eliminating unit 130, even if the packets not including video data to make reproduction timing have been eliminated, any difficulty in reproduction is not produced, and thereby, a data quantity to be flowed into the network can be reduced. (In an example in FIG. 8, a rate of 32.5 Mbps is slowed to an averaged rate of 18 Mbps.)

After this null packet eliminating processing, packets packed into an IP packet from a network I/F 140 [refer to (d) of FIG. 8 are transmitted to a communication channel (network) (communication channel such as Internet) 200.

Generally, packets have been transmitted via the network accurately have seldom reached with equal intervals. Therefore, the reception side 300 needs to take into consideration, such as jitters, disappearances, replacements of sequence of the packets (usually, IP packets). Therefore, the system firstly transmits packets received at a network I/F 310 to a network adjusting device 320.

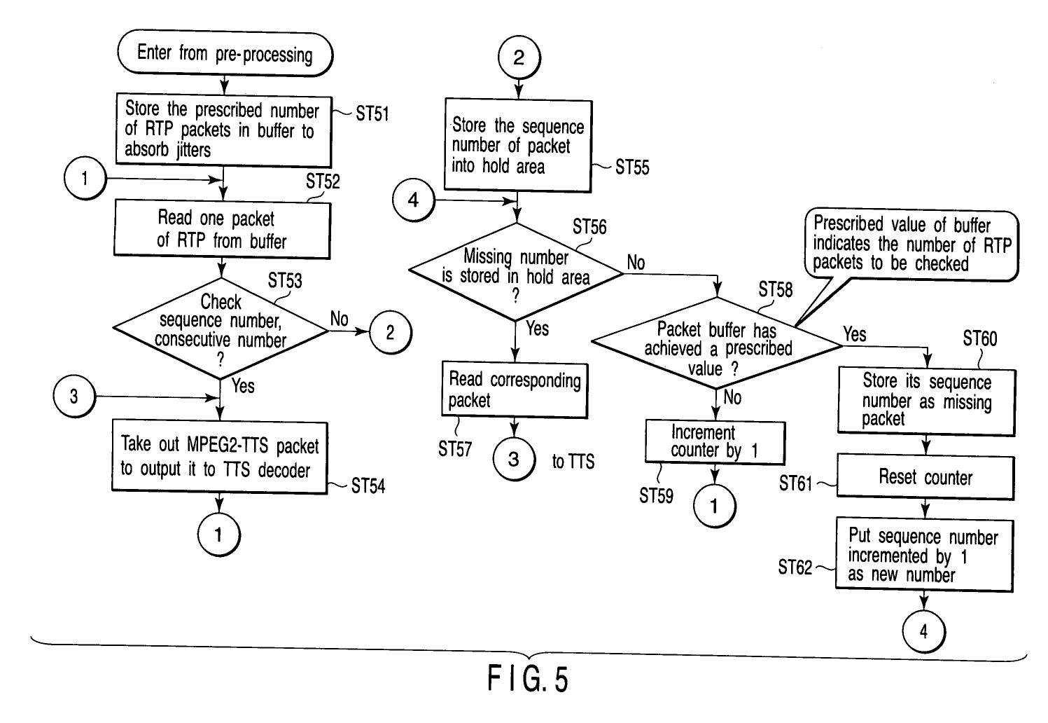

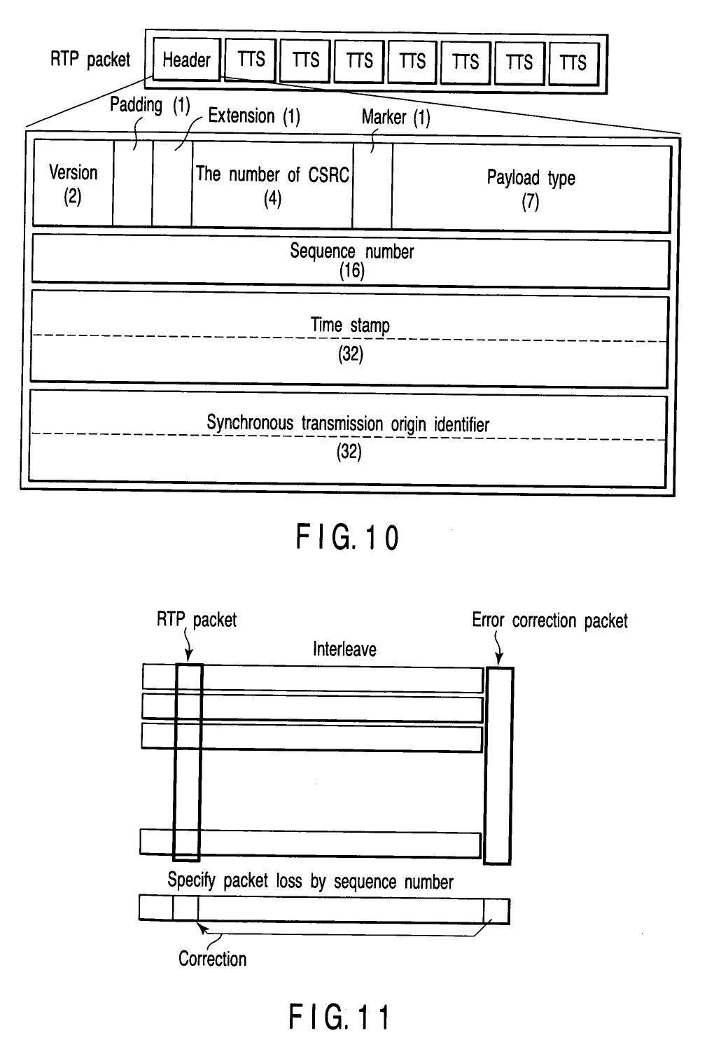

The network adjusting device 320 has a buffer memory 322 to store a certain quantity of packets. The temporal storing in the buffer memory 322 enables absorbing jitters caused in a transmission process and a reception process, etc. A protocol such as an RTP/RTCP (RFC1889) can detect the disappearances and displacements of the packets in the received MPEG2-TTS. When the replacements of the packets have been detected, the network adjusting device 320 can recover correct sequence in accordance with sequence numbers (refer to FIG. 10) put to headers of each packet or at every group thereof (describe later with reference to FIG. 5).

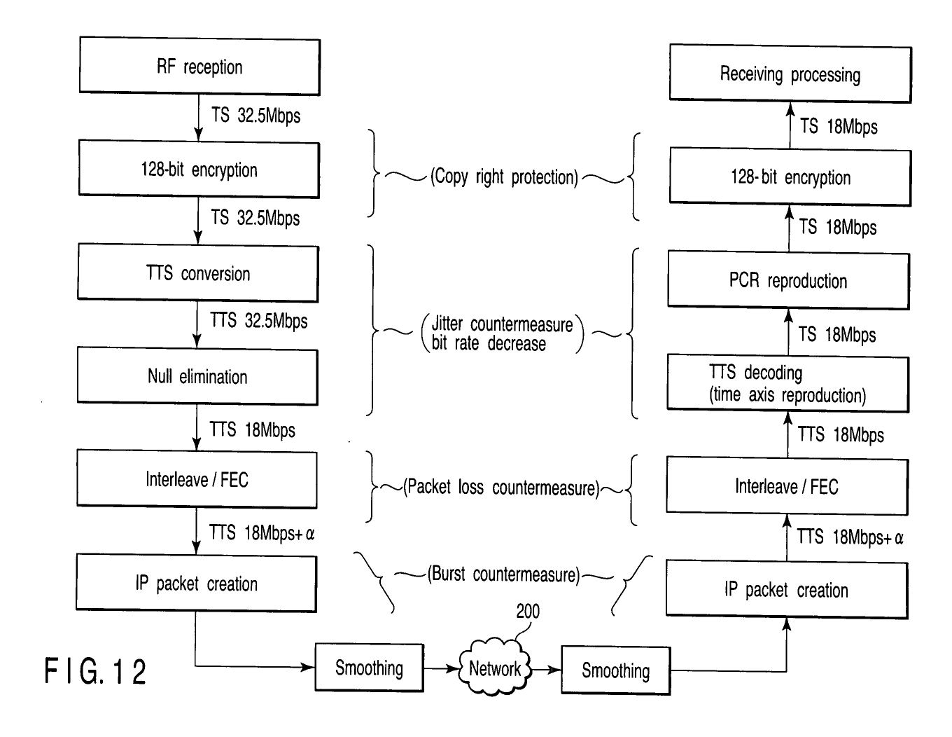

When intending to correct the disappearances of the packets, the network adjusting device 320 specifies which packet has been lost in accordance with the sequence numbers (FIG. 10) to insert a forward error correction (FEC), etc., which processes corrections on the basis of redundancy packets (describe later by referring to FIG. 11). With these processing, the network adjusting device 320 takes out the packets in the MPEG2-TTS (hereinafter, referred to as TTS packets) with correct values (correct data contents)/correct sequences to transmit them to a TTS decoder 330.

If the TTS decoder 330 transmits the packets in the MPEG2-TS (hereinafter, referred to as TS packets) in accordance with the time stamps of the TTS packets [t1, t2, . . . , in (b) and (c) of FIG. 2, or TTS in (e) of FIG. 8], the video is reproduced. However, and if nothing is done, since the TTS decoder 330 utilizes a built-in clock at the reception side 330 as a reference, the reproducing time (timing) is probably differs from an actual time at the transmission side. Accordingly, in this embodiment, the network adjusting device 320 adjusts the network by varying the timing to transmit the MPEG-TS from the TTS decoder 330 to an MPEG decoder 340. (A specific embodiment for the adjustment is described later.)

FIG. 2 exemplifies a packet structure change for eliminating null packets after converting the MPEG2-TS into the MPEG2-TTS. The (a) of FIG. 2 shows an example of an input to the TTS conversion unit 120, and the (b) of FIG. 2 shows an example of an output from the TTS conversion unit 120 or an example of an input to the null packet eliminating unit 130. The (c) of FIG. 2 exemplifies an example of an output from the eliminating unit 130 (before packing into IP packet). In a pre-stage in which the output from the eliminating unit 130 is transmitted to the communication channel 200, the network I/F 310 packs the output into the IP packet, and an IP packet string exemplified in (d) of FIG. 8 (all null packets are eliminated and averaged rate is decreased by the elimination) is transmitted to the communication channel 200.

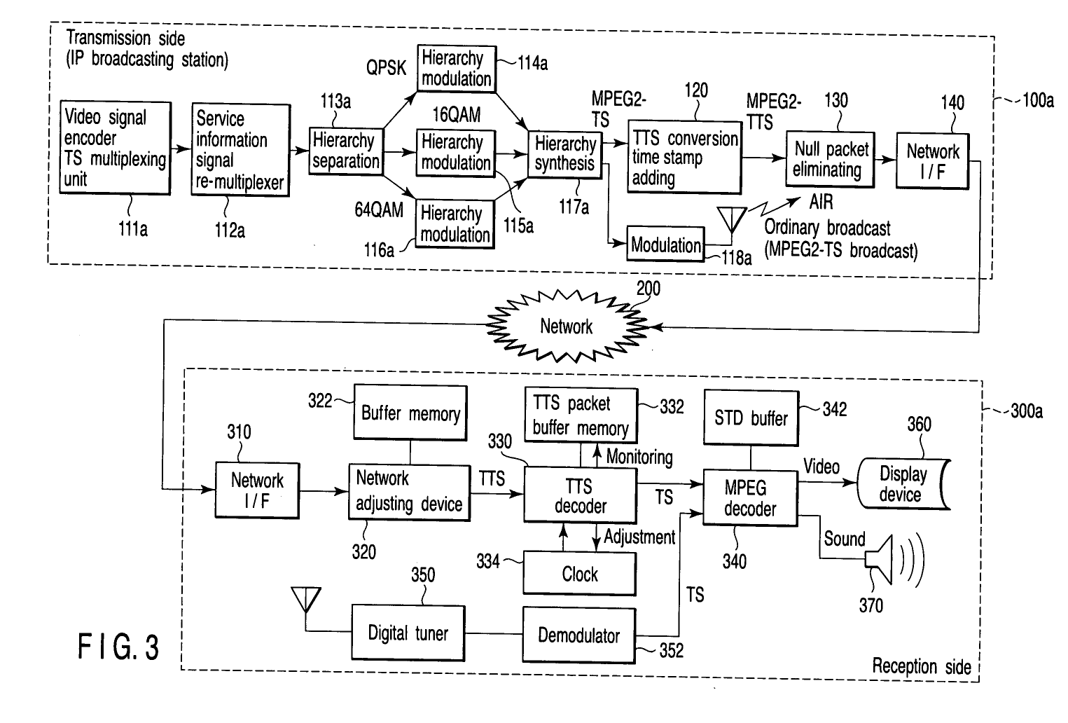

FIG. 3 is the explanatory view explaining the IP broadcasting time synchronization system regarding another embodiment of the present invention. This synchronization system differs by a configuration of a transmission side 100a in FIG. 1. Since structures of data to be transmitted are different from each other in FIG. 1 and FIG. 3, an operation of a reception side 300a in FIG. 3 is not the same as that of FIG. 1; however, block configurations at the reception sides do not differ from each other in FIG. 1 and FIG. 3. In the configuration in FIG. 3, a service information (SI) signal multiplexer 112a re-multiplexes SI onto an output from a video signal encoder (TS multiplexing unit) 111a. The multiplexer 112a generates an output stream at a fixed transmission rate suitable for hierarchical transmission in a segment structure from input streams at a plurality of ports differing in transmission rates. A parity is added to the generated stream by an outer code error correction encoding unit (not shown), such as a Reed Solomon encoding unit.

After this, for performing the hierarchical transmission, a hierarchy separating unit 113a hierarchically separates an input signal in accordance with a specification from hierarchy information to input signals in the separated each hierarchy (3 systems at a maximum) to hierarchy modulators 114a-116a, respectively. These modulators 114a-116a conduct the following parallel processing (three kinds of hierarchy modulation: QPSK, 16 QAM and 64 QAM) to each input signal, respectively. That is to say, the parallel processing conducts delay corrections to adjust delays at every hierarchy caused by energy diffusion, interleave, etc., bite-interleave to extract an function of an outer code [Reed Solomon (RS) code], bit-interleave to extract a function of an inner code, or the like. Then, after performing carrier modulation, a hierarchy synthesis unit 117a hierarchically synthesizes each input signal.

The signal (MPEG2-TS) hierarchically synthesized at the synthesis unit 117a is input to a time interleave unit (not shown) and a frequency interleave unit (not shown) in order to secure a moving reception function, a multi-path-resistant function and the like. The MPEG2-TS obtained in such a manner is air-played by applying prescribed modulation by a modulation unit 118a and/or passed though the TTS conversion unit 120, the null packet eliminating unit 130 and the network interface unit 140 to be transmitted to the communication channel (the Internet, etc.) 200.

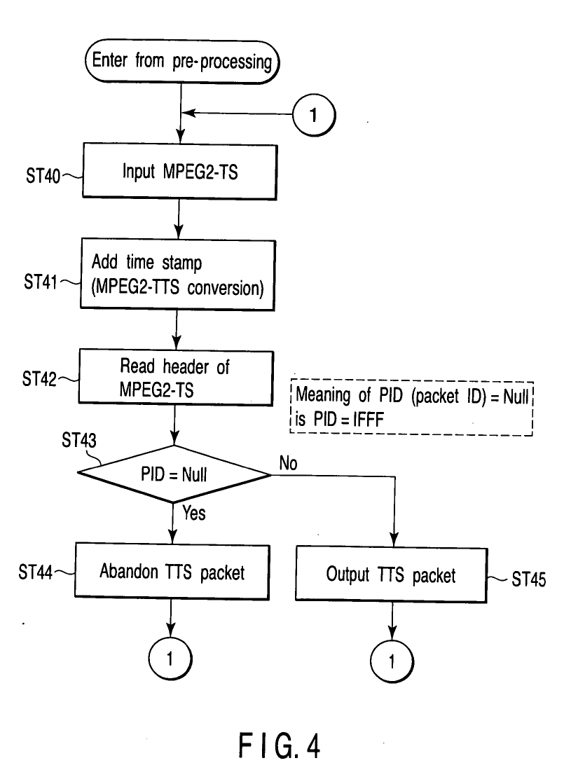

FIG. 4 is the flowchart explaining the example of the procedure to convert the MPEG2-TS into the MPEG2-TTS to output it. This conversion processing can be executed through the firmware in the TTS conversion unit 120 in FIG. 1 or FIG. 3. In other words, when the MPEG2-TS [refer to 188-bite TS1-TS14 in (a) of FIG. 8] to the conversion unit 120 (step ST40), the time stamp at achieving an inlet port of the processing unit 120 [refer to TTS of 4-bite in (b) of FIG. 8 is added to the packet of the MPEG2-TS (step ST41).

Next, the header of the MPEG2-TS with the time stamp added thereto is read out (step ST42), and a packet ID (PID) in the ‘MPEG2-TS header with the time stamp added thereto’ is checked (step ST43). Here, if the PID is represented by “PID=IFFF” meaning a null packet (Yes, in step ST43), the packet (TTS packet) is the null packet, so that it is abandoned (step ST44) then the conversion processing returns to the step ST40. In contrast, if the PID is not represented by “PID=IFFF” meaning the null packet (No, in step ST43), since the packet (TTS packet) is a packet including effective information, the conversion processing outputs it as the TTS packet (step ST45) to return to the step ST40.

As mentioned above, all null packets are removed from a data stream [(b) of FIG. 8 of the MPEG2-TTS with the time stamp added thereto, in which the null packets has been included [(c) of FIG. 8]. And a data stream [(d) of FIG. 8 of the MPEG2-TTS packed in the IP packet is transmitted to the communication channel (the Internet, etc.) 200 via the interface unit 140.

The data stream of the MPEG2-TTS transmitted from the interface unit 140 to the communication channel (the Internet, etc.) 200 can be structured to have the RTP packet in which a header is added to a packet group with the TS packets (TTS packets) of the prescribed number of the time stamps gotten together therein.

FIG. 10 is the explanatory view explaining the example of the data structure of the RTP packet. The header of the RTP packet is structured to include information of a standard version defining the data structure, padding, expansion information, the number of contributing source (CSRC), a marker, a payload type, a sequence number, a time stamp, and a synchronous transmission origin identifier. The sequence number here indicates original sequence of the RTP packet on the transmission side. The time stamp indicates the time (or timing) at which the RTP packet has been generated. The identifier specifies the transmission origin of the RTP packet to specify a partner (transmission origin) to be reproduced at the reception side in synchronization with the transmission side.

FIG. 11 is the explanatory view explaining the example of the FEC used for the RTP packet. A plurality of RTP packet groups each having the structure shown in FIG. 10 are interleaved and error correction packets are added to the groups. The existence of a missing number at the reception side among sequence numbers which have been consecutive at the transmission side predicts that any information missing has occurred in a communication process. In this case, the FEC corrects the site with the RTP packet missed thereat by using the error correction packet to achieve data transfer without missing the sequence number (if this error correction has resulted in failure, the FEC re-communicates or receives information regardless of block noise, etc., caused by information missing). In addition, the processing of the FEC is not essential for this synchronization system.

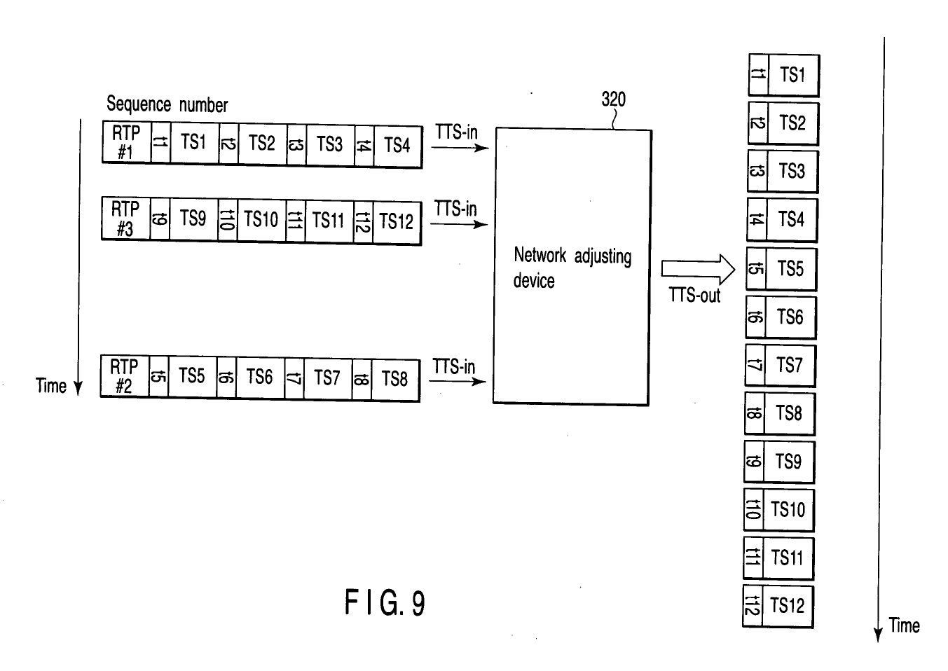

FIG. 9 exemplifies how the packets in the MPEG2-TTS are re-arranged to be output when the MPEG2-TTS including the above-mentioned RTP packet groups (original sequence is known from sequence number) has been input to a network adjusting device 320.

FIG. 5 is a flowchart explaining an example of a procedure to appropriately correct the sequences of the received TTS packets to normal sequence and output it in the normal sequence at the reception side. The TTS packets received at the network interface unit 310 in FIG. 1 or FIG. 3 are once stores in the buffer memory 322 to absorb the jitters (step ST51). After this, one packet of the RTP (refer to TS 1, etc., with t1 added in FIG. 9, or to TTS in FIG. 10) is returned from the buffer memory 322 to the network adjusting device 320 (step ST52).

Although the RTP packets have been inputting to the buffer memory 322, the network adjusting device 320 checks the sequence numbers from the buffer memory 322 and, if the numbers are not arranged in the normal sequence, the network adjusting device 320 replaces the sequence of the numbers. Here, the network adjusting device 320 reads in the header of the RTP from the buffer memory 322 to replace the numbers on the basis of the sequence numbers in the header. In other words, the information (#1, #3 and #2 of RTPs in example in FIG. 9) of the sequence numbers (FIG. 10) is written in the header of the RTP packets returned from the buffer memory 322. If the sequence numbers are consecutive numbers (Yes, in step ST53), the network adjusting device 320 determines that the sequence is normal and outputs the TTS packet to the decoder 330 at that time (step ST54) then returns to the step ST52.

If the sequence numbers are not the consecutive numbers (No, in step ST 53), the network adjusting device 320 determines that the sequence is not normal and stores the sequence number of the RTP packet at that time in a hold area of a work memory (not shown) (step ST55). For instance, when the sequence number of the packet has been output just before is #1, and if the sequence number of the packet at this time is #3, the network adjusting device 320 determines that the sequence is not normal. In that case, if the information of the missing sequence number (here, #2) has been stored in a hold area (not shown) (Yes, in step ST56), the network adjusting device 320 reads the packet corresponding to the missing sequence number from the buffer memory 322 (step ST57), and outputs the TTS packet at that time to the TTS decoder 330 (step ST54) to return to the step ST52.

If the information of the missing sequence number (here, #2) has not been stored in the hold area (not shown) (No, in step ST56), the network adjusting device 320 checks whether or not the number of the packets (RTP packets of which the sequence numbers are to be checked) has already reached a prescribed value (prescribed value is, for example, corresponds to a state where the buffer memory 322 is filled). If the number has not yet reached the prescribed value (No, in step ST58), the network adjusting device 320 counts up by 1 a counter (not shown) counting the number of the stored RTP packets to return to the step ST52 and reads another RTP packet. If the number has already reached the prescribed value (Yes, in step ST58), the network adjusting device 320 stores the sequence number at that time as the missing packet into a work memory (not shown) (step ST60) and resets the counter (not shown) has been counting the number of the stored RTP packets (step ST61). The network adjusting device 320 then increments the sequence number by 1 (step ST62) then retunes to step ST56.

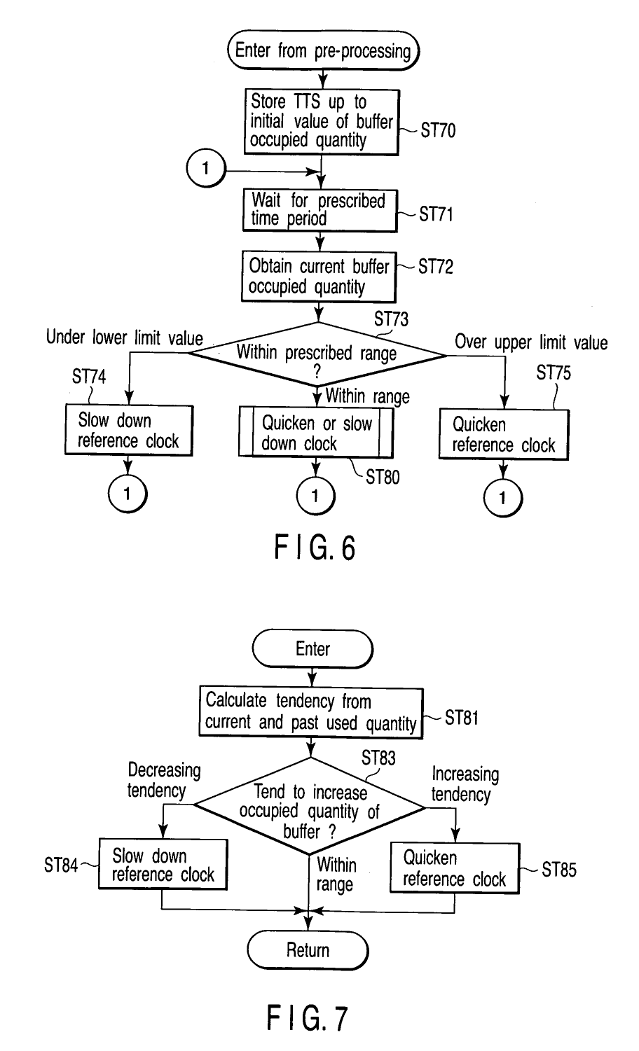

FIG. 6 is the flowchart explaining the example of the clock adjustment procedure at the reception side. At first, the reception side stores the TTS packets by around a half of the capacity of the TTS packet buffer 332 (step ST70), waits for a prescribed time period (step ST71), and then acquires information on a current occupied quantity of the buffer 332 (step ST72). The TTS decoder 330 firstly transmits the TS packets to the MPEG decoder 340 in accordance with the time stamps on the basis of the current built-in clock (not shown). After this, if the TTS packets in the buffer memory 322 rarely varies in a quantity for a certain time period (within a range of step ST73), the TTS decoder 330 conducts prescribed clock increasing/decreasing processing (step ST80), or does not conduct this processing but continuously transmits the TS packets by the current clock.

If the quantity of the TTS packets in the buffer memory 322 for the certain time period, when the occupied quantity of the current buffer 332 under-runs the prescribed range defined in advance (be in danger of running out of buffer), the TTS decoder 330 decreases the speed of the reference clock so as to slow down a pace to read out the packets from the buffer 332 (step ST74). On the contrary, if the occupied quantity exceeds the prescribed range (be in danger of overflow of buffer), the TTS decoder 330 increases the speed of the reference clock so as to speed up the pace to read out the packets from the buffer 332 (step ST75). When the occupied quantity is within the prescribed range, the TTS decoder 330 reads out the packets at a prescribed pace (step ST80).

FIG. 7 is the flowchart explaining another example of the clock adjustment procedure at the reception side. The TTS decoder 330 firstly checks use trend from a current and a past buffer-used quantities (step ST 81). If the check resulted in the trend of increase in occupied quantity of the buffer 332 for a cetin time period, the TTS decoder 330 determines that its own built-in clock is slow in speed and increases the speed of the clock (step ST85) then continues to transmit the TS packets in accordance with the time stamps. And when the packet quantity occupying the buffer 332 exceeds a prescribed upper limit value, the TTS decoder 330 immediately speeds up the clock speed (step ST75 in FIG. 6).

On the contrary, when the occupied quantity of the buffer 332 is in reducing trend within the certain time period, the TTS decoder 330 determines that its own clock is fast in speed to increase the speed of the clock (step ST84) and continues to transmit the TS packets in accordance with the time stamps. And if the packet quantity occupying the buffer 322 is under the prescribed lower limit value, the TTS decoder 330 immediately slows down the clock (step ST74 in FIG. 6).

With proceeding like this manner, (even if a data reception space of the MPEG2-TTS to be received by the reception side 300 from the communication channel 200 is not constant), the reproducing time can be maintained constant averagely.

The changing quantity of the clock may each vary or fix in accordance with the magnitude of degrees of an increasing tendency and a decreasing tendency or depending on the time when the clock exceeds a threshold. The determining method in the step ST73 in FIG. 6 or in the step ST83 in FIG. 7 are, as mentioned above, may use both or either tendencies and/or the threshold. The value of the clock after varying may be continued in use or put back to an initial value when a program or a channel is changed.

An actual clock control method can control a buffer quantity by speeding up the built-in clock when the occupied quantity in the buffer 332 exceeds the threshold, and on the contrary, by slowing down in speed the built-in clock when it is under the threshold. The control of the occupied quantity of the buffer 332 actually results in an operation equivalent to a phase-locked loop (PLL) operation in which the clock used for adding the time stamps at the transmission side and the clock at the reception side have very long time constants, respectively.

Since processing after this operation is the same as that of an ordinary terrestrial digital broadcast receiver, a receiving apparatus for both network and radio waves can be provided in a manner of adding to the ordinary receiver.

FIG. 12 is the explanatory view explaining the example of the transfer rate change accompanied by the processing at the transmission side and the transfer rate change accompanied by the processing at the reception side. The transmission side can slow an averaged transfer rate to around (or not more than) 18 Mbps even of the heavy MPEG2-TS initially having a transfer rate of 32.5 Mbps by eliminating all null packets after converting into the MPEG2-TTS. For dealing with data loss (packet loss), etc., in the following network communication process, the synchronization system performs the interleaving and the FEC of the RTP packets. Although this processing slightly increases the transfer rate (to 18 Mbps+α), it may neglect in comparison with the original transfer rate (32.5 Mbps). The FEC processing is not always necessary for this synchronization system; the system may make an arbitrary selection for the FEC processing in FIG. 12.

The generation/reproduction processing of the null packets which have been eliminated at the transmission side is not required at the reception side (because each TTS packet has its own time stamp, respectively), so that processing at a high-rate (32.5 Mbps) is not necessary at the reception side.

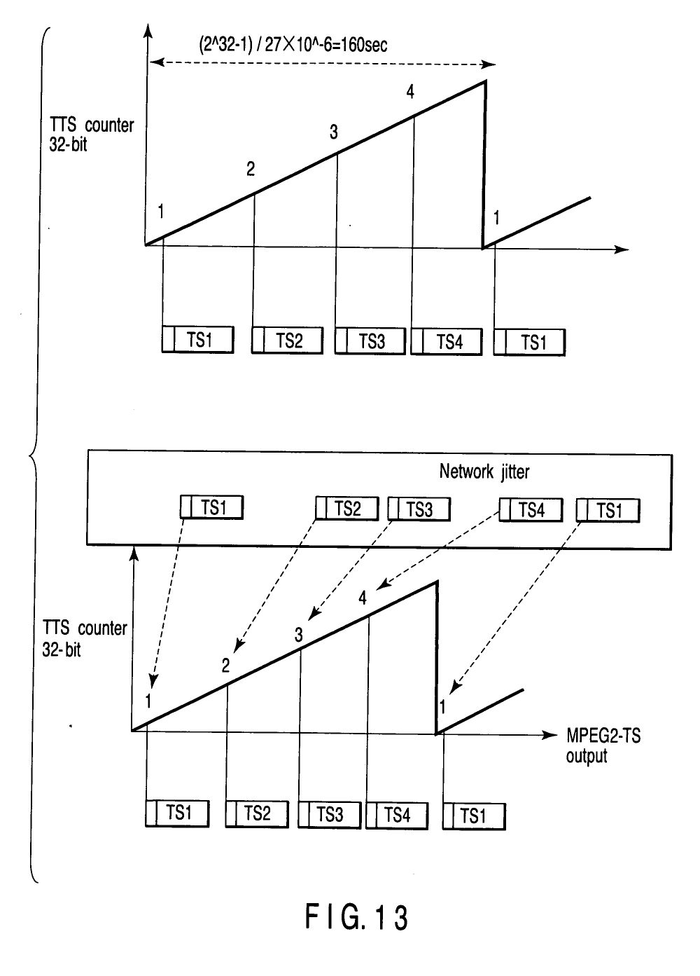

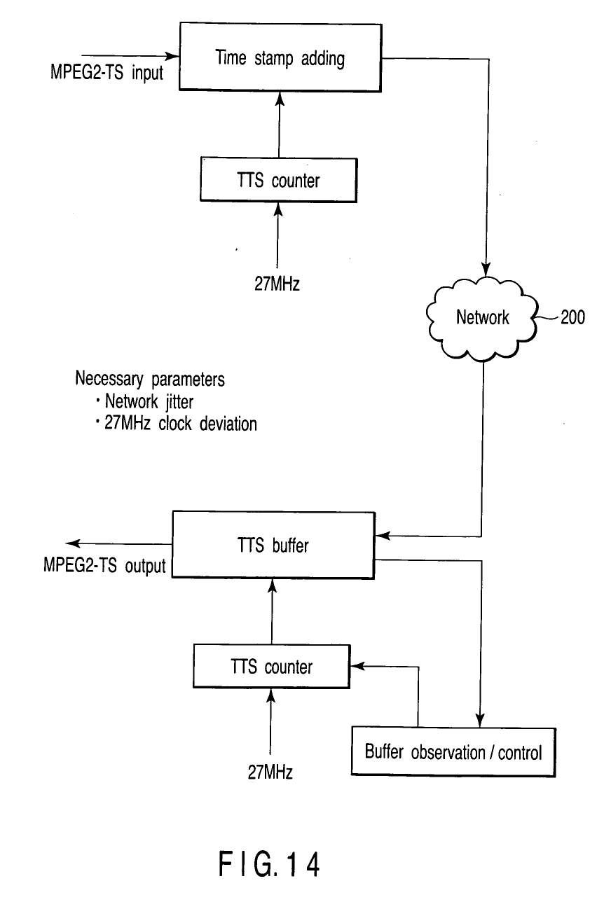

FIG. 13 is the conceptual view explaining the processing to reduce the network jitters. And FIG. 14 is the explanatory view explaining the configuration example to perform the clock recovery processing. Even if the TTS packets transmitted via the communication channel 200 have been brought into a state without original time intervals due to the jitters, as shown at a lower stage in FIG. 13, the synchronization system stores once the TTS packets into a TTS buffer in FIG. 14 (or, buffer memory 322 and/or TTS packet buffer 332 in FIG. 1 and FIG. 3) to read out it with a clock without any jitter. Then, the system can recover the original time intervals as shown at an upper stage in FIG. 13.

A TTS buffer in FIG. 14 corresponds to the TTS packet buffer 332 in FIG. 1 or FIG. 3. In FIG. 14, the TTS buffer employs a 27 MHz clock as a clock corresponding to the clock 334 in FIG. 1 or FIG. 3. The processing to speed up the reference clock in FIG. 7 (step ST85) can be executed by quickening the count up with applying an offset to a counter value of the 27 MHz clock. The processing to slow down the reference clock in FIG. 7 (step ST84) can be executed by slowing the count up with applying an offset (in opposite direction to quicken the count up) to the counter value of the 27 MHz clock.

[Feature of Configuration in FIG. 1 or FIG. 3]

An IP broadcast system capable of reproducing without failures with no need to adjust at every time at the transmission side and the reception side to each other.

An IP broadcast system capable of slowing down the transfer rate by eliminating excess data.

A receiving apparatus capable of receiving both IP and ordinary radio waves.

### Effect of Embodiments of the Invention

Reproduction can be performed without failures by adjusting the clock at the reception side.

Since the reception side performs the adjustment independently from the transmission side, the transmission side needs not to communicate at every time for adjusting and controlling.

Deterioration in image quality, etc., by interleaving data at the transmission (broadcasting station) side.

Since the same video data as that of the broadcast by the current radio waves even in the IP broadcast, a receiver for the IP broadcast can be shared with the broadcast by the current radio waves.

### Effect Depending on Types of the Embodiments

The digital broadcasting method regarding an embodiment of the present invention adds time stamps to each packet of the first data stream (MPEG2-TS) to generate the second data stream (MPEG2-TTS) (step ST41 in FIG. 4) and transmits the second data stream (MPEG2-TTS) to the communication channel (200) (step ST45 in FIG. 4).

Since each packet transmitted has each time stamp, even if the timing (or sequence) of the packets of the second data stream (MPEG2-TTS) received at the reception side has deviated from the timing at the transmission side, the reception side can re-arrange the packets at correct timing (and correct sequence) (refer to FIG. 9). Thereby, the reception side can reconstruct the second data stream (MPEG2-TTS) to the same one as that of the first data stream (MPEG2-TS) at the transmission side in accordance with the correct timing (and correct sequence)

Accordingly, when the transmission side deletes null packets and decreases the data transfer rate, the broadcasting method regarding the embodiment can synchronize the broadcasting time between the transmission and the reception sides without generating/reproducing, at the reception side, the deleted null packets.

The reception side to receive the packets transmitted via the communication channel needs not to generate/reproduce the packets (null packets) abandoned at the transmission side (and also, since there is no need to transmit the packets with adding the null packets therein), and can effectively decrease the averaged rate of the data transfer on the communication channel.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A digital broadcasting method, comprising:
adding time stamps to each packet in an MPEG-encoded first data stream to generate a second data stream; and
transmitting the second data stream to a communication channel.

2. The digital broadcasting method according to claim 1, further comprising:
synchronizing a plurality items of information demodulated by any one of demodulation methods one or more kind to obtain the first data stream.

3. The digital broadcasting method according to claims 1, further comprising:
eliminating a null packet from the second data stream before transmitting the second data stream to the communication channel when the generated second data stream includes the null packet.

4. The digital broadcasting method according to claim 1, wherein the second data stream is structured by adding a prescribed packet group header to a packet group in which a plurality of packets with the time stamps added thereto are gotten together, and the packet group header is structured so as to include information indicating sequence of the packet group included in the second data stream to be transmitted to the communication channel.

5. The digital broadcasting method according to claim 4, wherein the packet group header includes time stamp information of the packet group and/or identification information of an transmission origin to transmit the second data stream.

6. The digital broadcasting method according to claim 5, wherein each of the packet groups is structured so as to be added error correction information.

7. A data processing method of a digital broadcast, comprising:
receiving a second data stream generated by adding time stamps to each packet in an MPEG-encoded first data stream;
arranging packets in the received second data stream along with a time series of the time stamps added to each packet; and
converting the arranged packets in the second data stream into a data stream in a format corresponding to the first data stream.

8. The data processing method according to claim 7, when the received second data stream has a structure to add a prescribed packet group header to a packet group in which a plurality of packets with the time stamps added thereto are gotten together, and the packet group header includes information indicating sequence of the packet groups included in the second data stream, the method further comprises:
converting the second data stream into the data stream in the format corresponding to the first data stream in sequence according to the information indicating the sequence of the packet groups.

9. The data processing method according to claim 8, when the packets in the second data stream are buffered once in converting the packets in the second data stream into packets in formats corresponding to the first data stream, the method further comprises:
storing the packets in the second data stream into a buffer to check an occupied quantity of the packets to the buffer;
slowing down a pace to read out the packets from the buffer when the occupied quantity is under a prescribed range defined in advance;
speeding up the pace to read out the packets from the buffer when the occupied quantity exceeds the prescribed range; and
reading out the packets from the buffer at a prescribed pace when the occupied quantity is within the prescribed range.

10. The data processing method according to claim 9, in reading out the packets from the buffer at a prescribed reference clock when the occupied quantity is within the prescribed range, the method further comprises:
slowing down the reference clock when the occupied quantity is tend to decrease; and
quickening the reference clock when the occupied quantity is tend to increase.

11. A receiving apparatus of a digital broadcast, comprising:
a receiving unit which receives, from a communication channel, a second data stream generated by adding time stamps to each packet in an MPEG-encoded first data stream;
an arranging unit which arranges packets in the received second data stream along with a time series of the time stamps added to the packets; and
a converting-unit which converts the arranged packets in the second data stream into packets in a data stream in the same format as that of the first data stream.

12. The receiving apparatus of a digital broadcast according to claim 11, further comprising:
a digital tuner which receives a digital broadcast stream encoded in the same format as that of the first data stream; and
a decoder which receives to decode either one or both of a data stream in the same format as that of the first data stream from the converting unit and a digital broadcast stream encoded in the same format as that of the first data stream from the digital tuner to decode the received data stream(s).

13. The receiving apparatus of a digital broadcast according to claim 12, when the received second data stream has a structure to add a prescribed packet group header to a packet group in which a plurality of packets with the time stamps added thereto are gotten together, and the packet group header includes information indicating sequence of the packet groups included in the second data stream, wherein the converting unit converts the second data stream into a data stream in a format corresponding to the first data stream in sequence according to the information indicating the sequence of the packet groups.

14. The receiving apparatus according to claim 11 further comprising:
a buffer which buffers the packets in the second data stream once in converting the packets in the second data stream into a packet in a format corresponding to the first data stream; and
a processing unit which checks an occupied quantity of the packets to the buffer, slows down a pace to read out the packets from the buffer when the occupied quantity is under a prescribed range defined in advance, speeds up the pace to read out the packets from the buffer when the occupied quantity exceeds the prescribed range, and reads out the packets from the buffer at a prescribed pace when the occupied quantity is within the prescribed range.

15. The receiving apparatus according to claim 14, in reading out the packets from the buffer at a prescribed reference clock when the occupied quantity is within the prescribed range, the apparatus further comprises a control unit which slows down the reference clock when the occupied quantity is tend to decrease, and quickens the reference clock when the occupied quantity is tend to increase.
